(19) United States
(12) Patent Application Publication
(10) Pub. No.: US 2026/0361226 A1
(43) Pub. Date: Nov. 12, 2026

(54) CONTROL CIRCUIT AND CONTROL METHOD FOR LLC RESONANT CONVERTER CIRCUIT

(71) Applicant: SUMIDA CORPORATION, Tokyo (JP)

(72) Inventor: Hiroyuki MIYAZAKI, Natori City, Miyagi (JP)

(21) Appl. No.: 19/487,032

(22) PCT Filed: Jun. 5, 2023
(86) PCT No.: PCT/JP2023/020860

§ 371 Date: Nov. 24, 2025

(51) Int. Cl. H02M 3/335; H02M 3/00

(52) U.S. Cl. CPC H02M 3/33573; H02M 3/01

(57) ABSTRACT

This control circuit (30) for an LLC resonant converter circuit is equipped with: a drive control circuit (50) that outputs, to a drive circuit, a drive signal indicating a switching frequency corresponding to the voltage level of a frequency control terminal and a duty ratio corresponding to the voltage level of a duty control terminal; a detection circuit (40) that detects an output voltage from the LLC resonant converter circuit; a voltage divider circuit (60) that divides an input voltage and applies same to the duty control terminal as a duty control voltage; and a regulation circuit (70) that is connected to the voltage divider circuit and the detection circuit and can adjust the duty control voltage and a frequency control voltage, and which, in response to a switch from an input of a first instruction signal to a second instruction signal, changes the duty control voltage so that the duty ratio indicated by the drive signal increases and changes the frequency control voltage so that the switching frequency indicated by the drive signal decreases.

### TECHNICAL FIELD

The present invention relates to an LLC resonant converter circuit.

### BACKGROUND ART

In an LLC resonant converter circuit, frequency control is performed using a feedback signal corresponding to output power from a secondary circuit. For example, Patent Document 1 discloses a current resonance type converter device including a DC power supply, a converter transformer, series circuits of first and second switching elements, series circuits of a primary winding of the converter transformer and a resonant capacitor, a rectifying and smoothing circuit that is connected to a secondary winding of the converter transformer and rectifies and smooths power obtained in the secondary winding to supply it to a load, a converter control circuit that controls an ON/OFF frequency of the first and second switching elements, an operational amplifier that detects and amplifies a load voltage supplied to the load, and an optical coupling means that detects a change in an output voltage of the operational amplifier and feeds it back to the converter control circuit. In this device, the gain characteristic is stabilized from the light load to the heavy load by adjusting the gain of the operational amplifier based on the detection output of the load current detection circuit that detects the load current flowing in the load, and the abnormal oscillation due to the gain increase at the heavy load is prevented.

### CITATION LIST

### Patent Documents

Patent Document 1: JP 2005-39975 A

### SUMMARY OF THE INVENTION

### Problem to be Solved by the Invention

It is known that a through current due to a recovery current of the body diode of a switching element is generated in a case where the resonant condition deviates from the resonant condition assumed in the LLC resonant converter circuit, leading to an increase in switching loss and breakage of the switching element. This is called a resonance deviation phenomenon. In order to prevent this resonance deviation phenomenon, the switching frequency (operating frequency) of the switching element is controlled at or above the resonant frequency so that the switching frequency does not become lower than the resonant frequency.

FIG. 3 is a graph illustrating output characteristics in a general LLC resonant converter circuit.

In the example of FIG. 3, the operating frequency is controlled to be within a frequency range from a lower limit frequency fmin to an upper limit frequency fmax which are higher than the resonant frequency.

However, in the general LLC resonant converter circuit, as illustrated in FIG. 3, it is difficult to lower the converter output below a certain level even if the operating frequency is made higher.

The present invention has been made in view of such problems, and provides a control technique for an LLC resonant converter circuit that makes an output voltage continuously variable over a wide range.

### Means for Solving the Problem

According to the present invention, it is possible to provide a control circuit for an LLC resonant converter circuit, the control circuit controlling a switching frequency to be a frequency equal to or higher than a resonant frequency of a series resonant circuit, the LLC resonant converter circuit including the series resonant circuit, a drive circuit that is connected to the series resonant circuit and causes each of a plurality of switching elements to perform a switching operation based on a drive signal, a transformer that uses a resonant coil constituting the series resonant circuit as a primary winding, and a rectifier circuit that rectifies and smooths alternating current (AC) power generated in a secondary winding of the transformer, the control circuit including a drive control circuit that includes a frequency control terminal and a duty control terminal and outputs drive signals indicating a switching frequency corresponding to a voltage level of the frequency control terminal and a duty ratio corresponding to a voltage level of the duty control terminal to the drive circuit, a detection circuit that detects an output voltage from the LLC resonant converter circuit and stabilizes the output voltage to become a set voltage level, a voltage dividing circuit that divides an input voltage from a control power supply terminal and applies the divided voltage as a duty control voltage to the duty control terminal, and an adjustment circuit that is connected to the voltage dividing circuit and the detection circuit, is capable of adjusting the duty control voltage, and is capable of adjusting a frequency control voltage applied to the frequency control terminal based on the input voltage and an output voltage detected by the detection circuit, in which in response to switching from an input of a first instruction signal to an input of a second instruction signal, the adjustment circuit varies the duty control voltage such that a duty ratio indicated by the drive signal increases, and varies the frequency control voltage such that a switching frequency indicated by the drive signal decreases.

In addition, according to the present invention, it is possible to provide a control method for an LLC resonant converter circuit including a series resonant circuit, a drive circuit that is connected to the series resonant circuit and causes each of a plurality of switching elements to perform a switching operation based on a drive signal, a transformer that uses a resonant coil constituting the series resonant circuit as a primary winding, a rectifier circuit that rectifies and smooths alternating current (AC) power generated in a secondary winding of the transformer, a drive control circuit that includes a frequency control terminal and a duty control terminal and outputs drive signals indicating a switching frequency corresponding to a voltage level of the frequency control terminal and a duty ratio corresponding to a voltage level of the duty control terminal to the drive circuit, a detection circuit that detects an output voltage from the rectifier circuit and stabilizes the output voltage to become a set voltage level, a voltage dividing circuit that divides a voltage of input power from a control power supply terminal and applies the divided voltage as a duty control voltage to the duty control terminal, and an adjustment circuit that is connected to the voltage dividing circuit and the detection circuit, is capable of adjusting the duty control voltage, and is capable of adjusting a frequency control voltage applied to the frequency control terminal based on the input power and an output voltage detected by the detection circuit, the method including causing, in response to switching from an input of a first instruction signal to an input of a second instruction signal, the adjustment circuit to vary the duty control voltage such that the duty ratio of the drive signal increases and vary the frequency control voltage such that the switching frequency of the drive signal decreases.

### Effect of the Invention

According to the above aspect, it is possible to provide a control technique of an LLC resonant converter circuit that makes an output voltage continuously variable over a wide range.

### BRIEF DESCRIPTION OF THE DRAWINGS

FIG. 1 is a circuit diagram of an LLC resonant converter circuit (converter circuit) according to an embodiment.

FIG. 2 is a graph conceptually illustrating temporal change of a voltage at points A, B, C, and D and a drive signal at a point E in an adjustment circuit.

FIG. 3 is a graph illustrating output characteristics in a general LLC resonant converter circuit.

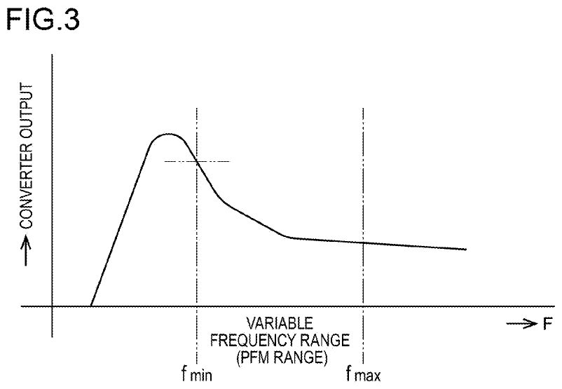

### DESCRIPTION OF EMBODIMENTS

Hereinafter, embodiments of the present invention will be described. Note that the following embodiments are examples, and the present invention is not limited to the configurations of the following embodiments.

### Circuit Configuration

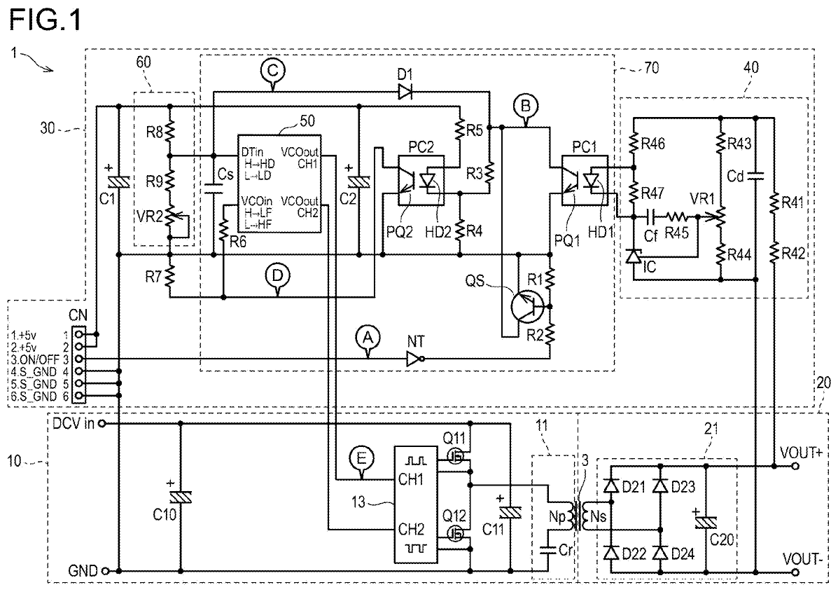

FIG. 1 is a circuit diagram of an LLC resonant converter circuit (hereinafter, it may be abbreviated as “converter circuit”) 1 according to an embodiment.

The converter circuit 1 includes at least a primary-side circuit 10 connected to a DC power supply and including a series resonant circuit 11, a transformer 3, a secondary-side circuit 20 that obtains alternating current (AC) power from the primary-side circuit 10 via the transformer 3, and a control circuit 30.

The primary-side circuit 10 includes the series resonant circuit 11, switching elements Q11 and Q12, a drive circuit 13, a capacitor C10, an input capacitor C11, and the like.

The primary-side circuit 10 is connected to an external DC power supply via an input terminal (DCVin).

The series resonant circuit 11 is formed by a primary-side coil Np of the transformer 3 and a resonant capacitor Cr connected in series. Therefore, the primary-side coil Np can also be referred to as a resonant coil.

The switching elements Q11 and Q12 are controlled to perform switching operation by the drive circuit 13. The direction of the current flowing through the resonant coil (primary-side coil Np) of the series resonant circuit 11 is switched by the switching operation of the switching elements Q11 and Q12.

For example, a field effect transistor (FET) is used as each of the switching elements Q11 and Q12, and an N-channel metal oxide semiconductor field effect transistor (MOSFET) is illustrated in FIG. 1. Therefore, the switching elements Q11 and Q12 may be referred to as transistors Q11 and Q12 in some cases.

The drain of the transistor Q11 is connected to the input terminal (DCVin) of the DC power supply, the source of the transistor Q11 is connected to the drain of the transistor Q12, and the source of the transistor Q12 is connected to the ground line from the ground terminal (GND).

As described above, in FIG. 1, the switching elements Q11 and Q12 connected in a half-bridge manner are illustrated, but can be replaced with two or more switching elements connected in a full-bridge manner.

The drive circuit 13 is connected to the transistors Q11 and Q12 so that gate-source voltages (hereinafter, it may be referred to as a VGS voltage) of the transistors Q11 and Q12 can be applied thereto.

The drive circuit 13 alternately applies a VGS voltage exceeding a threshold voltage to the transistor Q11 and the transistor Q12 to alternately switch ON/OFF states of the transistor Q11 and the transistor Q12 (perform switching operation). At this time, the drive circuit 13 switches ON/OFF states of the transistors Q11 and Q12 in accordance with the pulse period and the duty ratio of the drive signals (VCOoutCH1 and VCOoutCH2) from the drive control circuit 50.

The series resonant circuit 11 is connected to the source of the transistor Q11 and is provided between the drain and source of the transistor Q12. As a result, in a case where the transistor Q11 is in the ON state and the transistor Q12 is in the OFF state, the load current can flow through the drain-source path of the transistor Q11, the primary-side coil Np, and the resonant capacitor Cr. On the other hand, in a case where the transistor Q11 is in the OFF state and the transistor Q12 is in the ON state, the load current can flow through the resonant capacitor Cr, the primary-side coil Np, the drain-source path of the transistor Q12, by the power stored in the resonant capacitor Cr.

As described above, the direction of the current flowing through the primary-side coil Np is switched by the switching operation of the transistors Q11 and Q12.

The capacitor C10 absorbs a voltage change of a DC power supply connected between the input terminal (DCVin) and the ground terminal (GND).

The input capacitor C11 is connected to the drain of the transistor Q1 and the source of the transistor Q2, that is, connected in parallel to the transistors Q11 and Q12, and smooths the input voltage.

The transformer 3 includes the primary-side coil Np and a secondary-side coil Ns that are electrically insulated from each other, and a core, and magnetically couples the primary-side coil Np and the secondary-side coil Ns. FIG. 1 does not illustrate parasitic elements such as a magnetizing inductance (Lm) and a leakage inductance (Lr) of the transformer 3, and output capacitances and parasitic diodes in switching elements Q11 and Q12 to be described later.

The secondary-side circuit 20 includes output terminals (VOUT+) and (VOUT−), and outputs direct current (DC) power from these output terminals. The use form of the output DC power is not particularly limited. A load having various characteristics can be connected to the output terminal.

The secondary-side circuit 20 further includes the secondary-side coil Ns which is a secondary winding of the transformer 3, a rectifier circuit 21 which is connected to the secondary-side coil Ns and rectifies and smooths the AC power generated in the secondary-side coil Ns, and the like. The rectifier circuit 21 includes a bridge rectifier circuit including rectifier diodes D21, D22, D23, and D24, a capacitor C20, and the like. The AC power generated in the secondary-side coil Ns is converted into DC power by half-wave rectification by the bridge rectifier circuit and smoothing by the output capacitor C20.

The control circuit 30 can control the switching frequency of the switching elements Q11 and Q12 at a resonant frequency of the series resonant circuit 11 or higher, and can control the duty ratio of the switching operations of the switching elements Q11 and Q12. That is, the control circuit 30 can execute pulse frequency modulation (PFM) control and pulse width modulation (PWM) control, thereby making the output voltage from the converter circuit 1 (secondary side circuit 20) continuously variable over a wide range.

Here, the “wide range” is a voltage range including a low output range of a converter output that is difficult to realize only by frequency control in a band higher than the resonant frequency in the LLC resonant converter circuit, and a high output range that can be realized only by the frequency control.

More specifically, the control circuit 30 adjusts the voltage level from a predetermined lower limit voltage level in a predetermined low voltage region and stabilizes the voltage level at a set voltage level. The set voltage level is set to a level higher than the predetermined low voltage region. In the present embodiment, an example is shown in which the predetermined lower limit voltage level is set to zero, and the control circuit 30 adjusts the output voltage from the converter circuit 1 from zero and stabilizes the output voltage to a predetermined set voltage level. However, the predetermined lower limit voltage level is not limited to zero, and may be set to a voltage level in the predetermined low voltage region.

Herein, the “predetermined low voltage region” means a low output range of converter output in the LLC resonant converter circuit, which is difficult to realize only by frequency control in a band higher than the resonant frequency, and a voltage region including zero. In an LLC resonant converter circuit having an output power of 500 watts (W) or more that operates under normal design conditions that are not impractical design conditions where efficiency is significantly poor or circuit elements are lost, the predetermined low voltage region is, for example, in a range of equal to or more than 0 (V) and equal to or less than 5 (V).

The control circuit 30 includes a detection circuit 40, a drive control circuit 50, a voltage dividing circuit 60, an adjustment circuit 70, an input terminal block CN, and the like.

In the example of FIG. 1, the input terminal block CN includes control power supply terminals (a first terminal and a second terminal), an instruction signal terminal (a third terminal), and ground terminals (fourth terminal, fifth terminal, and sixth terminal).

A voltage supplied from a control power supply is input to the control power supply terminals, an OFF signal (corresponding to a first instruction signal) or an ON signal (corresponding to a second instruction signal) is input to the instruction signal terminal, and a ground line is connected to the ground terminals.

The drive control circuit 50 includes a frequency control terminal (VCOin terminal), a duty control terminal (DTin terminal), and output terminals (VCOoutCHI terminal, VCOoutCH2 terminal) for drive signals for two channels, and outputs drive signals indicating a switching frequency corresponding to a voltage level of the frequency control terminal and a duty ratio corresponding to a voltage level of the duty control terminal to the drive circuit 13. Hereinafter, the voltage applied to the frequency control terminal may be referred to as a frequency control voltage or a VCO voltage, and the voltage applied to the duty control terminal may be referred to as a duty control voltage or a DT voltage.

In the example of FIG. 1, the drive control circuit 50 is configured to decrease the pulse frequency of the drive signal to be output as the VCO voltage is higher within a predetermined range, increase the pulse frequency of the drive signal to be output as the VCO voltage is lower within the predetermined range, increase the duty ratio of the drive signal to be output as the DT voltage is higher within the predetermined range, and decrease the duty ratio of the drive signal to be output as the DT voltage is lower within the predetermined range.

The drive control circuit 50 may preferably include a frequency control terminal (VCOin terminal), a duty control terminal (DTin terminal), and output terminals of drive signals of two or more channels, and be capable of controlling the pulse frequency and the duty ratio of the drive signal as described above. A specific configuration thereof is not limited at all.

The voltage dividing circuit 60 divides an input voltage from the control power supply terminals of the input terminal block CN and applies the divided voltage as a duty control voltage (DT voltage) to the duty control terminal (DTin terminal) of the drive control circuit 50.

In the example of FIG. 1, the voltage dividing circuit 60 includes resistance elements R8 and R9 and a variable resistor VR2 connected in series between the control power supply terminals and the ground terminals, and a line connected to the duty control terminal of the drive control circuit 50 is connected between the resistance element R8 and the resistance element R9. As a result, the voltage input from the control power supply terminals is divided by the ratio of the resistance of the resistance element R8 to the combined resistance of the resistance elements R8 and R9 and the variable resistor VR2 and applied to the duty control terminal.

The upper limit level of the DT voltage applied to the duty control terminal as described above is determined by the resistance values of the resistance elements R8 and R9 and the variable resistor VR2, and corresponds to the upper limit (upper limit value of duty ratio) of the duty ratio controlled by the drive control circuit 50. That is, the voltage dividing circuit 60 determines the upper limit level of the DT voltage corresponding to the upper limit value of duty ratio (maximum duty ratio).

The detection circuit 40 detects an output voltage from the secondary-side circuit 20 and stabilizes the output voltage to a set voltage level. In the example of FIG. 1, the detection circuit 40 includes capacitors Cd and Cf, resistance elements R41, R42, R43, R44, R45, R46, and R47, a variable resistor VR1, a shunt regulator IC, and the like.

The capacitor Cd and the resistance elements R41 and R42 are connected in series between the output terminals (VOUT+) and (VOUT−) of the secondary-side circuit 20, and a series connection line of the resistance element R43, the variable resistor VR1, and the resistance element R44 and a series connection line of the resistance elements R46 and R47 and the shunt regulator IC are connected in parallel to the capacitor Cd. The branch line from the connection line between the resistance element R47 and the cathode of the shunt regulator IC is connected to the slider terminal (terminal connected to the slider) of the variable resistor VR1 via the capacitor Cf and the resistance element R45 connected in series. Further, a line extending from the reference terminal of the shunt regulator IC is connected to a connection line between the resistance element R45 and the slider terminal of the variable resistor VR1.

The variable resistor VR1 is provided so that the set voltage level of the output voltage (voltage between the output terminals (VOUT+) and (VOUT-)) from the secondary-side circuit 20 can be adjusted in a voltage region higher than the predetermined low voltage region. Since the voltage applied to the slider of the variable resistor VR1 is controlled by the shunt regulator IC to be the reference voltage, the output voltage is set by the ratio of the resistance of the variable resistor VR1 corresponding to the position of the slider, the resistance of the resistance element R43, and the resistance of the resistance element R44. As a result, the output voltage of the converter circuit 1 can be variably set. That is, the resistance elements R43 and R44 and the variable resistor VR1 can be described as an output variable circuit capable of variably setting the voltage level of the output voltage from the converter circuit 1, and the level of the output voltage set by the output variable circuit is described as a set voltage level.

As described above, in the detection circuit 40, the output voltage from the secondary-side circuit 20 is detected at both ends of the capacitor Cd, the detected output voltage is divided by the resistances of the variable resistor VR1 corresponding to the positions of the slider and the resistance elements R43 and R44 and applied to the reference terminal of the shunt regulator IC, and the divided voltage is controlled to be the reference voltage (for example, 2.5 V). Therefore, the circuit including the shunt regulator IC, the resistance elements R46 and R47, and the like can be described as a stabilization circuit that stabilizes the output voltage from the converter circuit 1 to be the set voltage level by comparing the divided voltage of the detected output voltage with the reference voltage.

The adjustment circuit 70 is connected to the voltage dividing circuit 60 and the detection circuit 40, and is capable of adjusting the DT voltage applied to the duty control terminal (DTin terminal), and is capable of adjusting the VCO voltage applied to the frequency control terminal (VCOin terminal) based on the input voltage from the control power supply terminals and the output voltage detected by the detection circuit 40.

In the example of FIG. 1, the adjustment circuit 70 includes photocouplers PC1 and PC2, a switching element QS, a rectifier diode DI, a capacitor Cs, resistance elements R1, R2, R3, R4, R5, and R6, and the like.

The photocoupler is electrically insulated between a primary side and a secondary side, and includes a light-emitting diode on the primary side and a phototransistor on the secondary side. The photocoupler PC1 includes a light-emitting diode HD1 on the primary side and a phototransistor PQ1 on the secondary side, and the photocoupler PC2 includes a light-emitting diode HD2 on the primary side and a phototransistor PQ2 on the secondary side.

Each of the photocouplers PC1 and PC2 enters an ON state (a light-emitting state of each of the light-emitting diodes HD1 and HD2 on the primary side) by application of an input voltage exceeding the non-light emitting forward voltage, and can increase or decrease the output impedance of the phototransistors PQ1 and PQ2 on the secondary side in response to increase or decrease of the current flowing through the light-emitting diodes HD1 and HD2 on the primary side in the ON state. In the following description, the current flowing through the light-emitting diode on the primary side of the photocoupler may be referred to as a diode current of the photocoupler.

The light-emitting diode HD1 of the photocoupler PC1 is connected in parallel to the resistance element R47. That is, in the light-emitting diode HD1, an anode is connected to a connection line between the resistance element R46 and the resistance element R47, and a cathode is connected to a connection point among the resistance element R47, a cathode of the shunt regulator IC, and the capacitor Cf.

In phototransistor PQ1 of the photocoupler PC1, a collector terminal is connected to a connection line between a cathode of the rectifier diode D1 and the resistance element R3 (corresponding to a photocoupler output line), and an emitter terminal is connected to a ground line.

The light-emitting diode HD2 and the resistance elements R4 and R5 of the photocoupler PC2 are provided in series in a line extending from the control power supply terminals and connected to the ground line. The light-emitting diode HD2 has a cathode connected to the resistance element R4 and an anode connected to the resistance element R5. In addition, the light-emitting diode HD2 and the resistance elements R4 and R5 connected in series are connected in parallel to the voltage dividing circuit 60.

The rectifier diode D1 and the resistance element R3 are provided in series to a branch line branched from an output line of the DT voltage from the voltage dividing circuit 60 to the duty control terminal, and the branch line is connected to a connection line between the cathode of the light-emitting diode HD2 and the resistance element R4. A cathode of the rectifier diode DI is connected to the resistance element R3, and a cathode of the light-emitting diode HD2 is connected to a connection line between the resistance element R3 and the resistance element R4.

In addition, the capacitor Cs is provided between the duty control terminal and the ground line. Soft start of the PFM control and the PWM control by the control circuit 30 is realized by the action of the capacitor Cs.

The phototransistor PQ2 of the photocoupler PC2 and the resistance element R6 are provided in series on a line extending from the frequency control terminal and connected to the ground line. In the phototransistor PQ2, the collector terminal is connected to the frequency control terminal via the resistance element R6, and the emitter terminal is connected to the ground line. In addition, the branch line from the connection line between the collector terminal of the phototransistor PQ2 and the resistance element R6 is connected to the ground line via the resistance element R7.

The switching element QS enters an ON state or an OFF state in response to an instruction signal input from the instruction signal terminal (third terminal). In the switching element QS, the collector terminal is connected to a line (photocoupler output line) extending from the collector terminal of the phototransistor PQ1, and the emitter terminal is connected to the ground line. The gate terminal of the switching element QS is connected to the ground line via the resistance element R1, and is connected to the instruction signal terminal (third terminal) via the resistance element R2 and a NOT circuit NT.

For example, a field effect transistor (FET) is used as the switching element QS, and the switching element QS may be referred to as a transistor QS.

In the example of FIG. 1, when the OFF signal is input from the instruction signal terminal, the OFF signal is inverted by the NOT circuit NT and input to the gate terminal, whereby the transistor QS enters the ON state. Conversely, when the ON signal is input from the instruction signal terminal, the ON signal is inverted by the NOT circuit NT and input to a gate terminal, whereby a transistor QS enters the OFF state.

When the transistor QS is turned on, the line (photocoupler output line) extending from the collector terminal of the phototransistor PQ1 and the cathode side of the rectifier diode DI drop to the ground level. As a result, as will be described later, the DT voltage applied to the duty control terminal becomes a voltage level corresponding to the lower limit value of duty ratio.

Here, the “lower limit value of duty ratio” indicates a value of the duty ratio, the value equal to or larger than zero, at which the output voltage from the converter circuit 1 (secondary-side circuit 20) can be set to a predetermined lower limit voltage level, and in the present embodiment, an example in which the lower limit value of duty ratio is zero is shown.

The control circuit 30 is further provided with capacitors C1 and C2.

The capacitors C1 and C2 are provided in parallel with each other between a line connected to the control power supply terminals (the first terminal and the second terminal) and the ground line connected to the ground terminals (fourth terminal, fifth terminal, and sixth terminal), and smooth an input voltage from the control power supply terminals.

### Operation

The converter circuit 1 having such a circuit configuration operates as follows.

The drive circuit 13 switches ON/OFF states of the transistors Q11 and Q12 in accordance with the pulse period and the duty ratio of the drive signals from the drive control circuit 50. Specifically, the drive circuit 13 switches the ON/OFF states of the transistor Q11 based on the drive signal output from the VCOoutCH1 terminal of the drive control circuit 50, and switches the ON/OFF states of the transistor Q12 based on the drive signal output from the VCOoutCH2 terminal of the drive control circuit 50.

As a result, the direction of the current flowing through the primary-side coil Np of the transformer 3 is switched. In a case where the transistor Q11 is in the ON state and the transistor Q12 is in the OFF state, a load current flows through a path between the drain and the source of the transistor Q11, the primary-side coil Np, and the resonant capacitor Cr, and the resonant capacitor Cr is charged. When the transistor Q11 is in the OFF state and the transistor Q12 is in the ON state, the load current flows in a direction opposite to the above case, through a path including between the drain and source of the transistor Q12, the resonant capacitor Cr, and the primary-side coil Np, by power charged in the resonant capacitor Cr.

In the primary-side circuit 10, a resonant current flows through the series resonant circuit 11 by the switching operation of the transistors Q11 and Q12, and the AC power is induced in the secondary-side coil Ns of the transformer 3. In the secondary-side circuit 20, the AC power generated by the secondary-side coil Ns is rectified and smoothed by the rectifier circuit 21, and is then converted into the DC power and output.

The detection circuit 40 detects an output voltage from the secondary-side circuit 20 and stabilizes the output voltage to a set voltage level. Specifically, the output voltage from the secondary-side circuit 20 is detected across both ends of the capacitor Cd, and this detected output voltage is divided by the resistances of the resistor elements R43 and R44 and the variable resistor VR1 corresponding to the position of the slider, applied to the reference terminal of the shunt regulator IC, and controlled so that the divided voltage becomes a reference voltage (for example, 2.5 V).

As a result, when the voltage of the slider of the variable resistor VR1 is about to become higher than the reference voltage, the diode current of the photocoupler PC1 increases, and when the voltage of the slider of the variable resistor VR1 attempts to become lower than the reference voltage, the diode current of the photocoupler PC1 decreases.

According to the photocoupler PC1, the output impedance on the secondary side increases or decreases in response to the magnitude of the diode current on the primary side. As a result, in a case where the transistor QS is in the OFF state, the voltage of the resistance element R3 changes and the diode current of the photocoupler PC2 changes, and as a result, the VCO voltage applied to the frequency control terminal (VCOin terminal) of the drive control circuit 50 is raised or lowered.

On the other hand, in the voltage dividing circuit 60, the input voltage from the control power supply terminals is divided and applied to the duty control terminal (DTin terminal) of the drive control circuit 50 (DT voltage).

Thus, the DT voltage applied to the duty control terminal and the VCO voltage applied to the frequency control terminal are adjusted by the adjustment circuit 70 according to the ON signal or the OFF signal input from the instruction signal terminal.

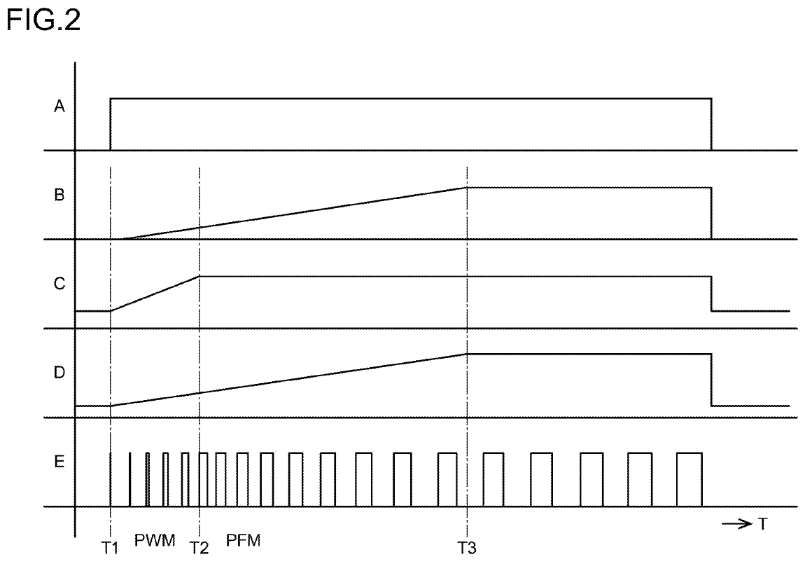

Hereinafter, the adjustment operation of the DT voltage and the VCO voltage by the adjustment circuit 70 will be described in detail with reference to FIG. 2. FIG. 2 is a graph conceptually illustrating a temporal change of a voltage at points A, B, C, and D and a drive signal at a point E in the adjustment circuit 70. Here, the voltage at the point C is equal to the voltage of the duty control terminal (DTin terminal), and the voltage at the point D is proportional to the voltage of the frequency control terminal (VCOin terminal).

As indicated by the graph at the point A, the OFF signal is input from the instruction signal terminal until the timing T1, the signal input from the instruction signal terminal at the timing T1 is switched from the OFF signal to the ON signal, and the input of the ON signal is continued after the timing T1.

In a state where the OFF signal is input, the OFF signal is inverted by the NOT circuit NT and input to the gate terminal of the transistor QS, and the transistor QS enters the ON state.

When the transistor QS enters the ON state, the line (photocoupler output line) extending from the collector terminal of the phototransistor PQ1 and the cathode side of the rectifier diode DI drop to the ground level. As a result, the voltage at the point B becomes the ground level (0 V), and the voltage at the point C becomes the lower limit value. Then, the drive signal output from the drive control circuit 50 indicates a duty ratio of zero, and as a result, the output power from the converter circuit 1 becomes zero.

Here, in the example of FIG. 1, the lower limit value of the voltage at the point C is determined by the forward voltage of the rectifier diode D1 and the collector-emitter saturation voltage of the transistor QS which is in the ON state, and corresponds to the DT voltage indicating the lower limit value of the duty ratio (the duty ratio of zero in the present embodiment).

At this time, since the diode current of the photocoupler PC2 becomes the maximum and the output impedance on the secondary side becomes the minimum, the voltage at the point D also becomes the lower limit value, and the VCO voltage also becomes the lower limit value. The switching frequency indicated by the drive signal output from the drive control circuit 50 is an upper limit frequency of a predetermined frequency range.

When the OFF signal is switched to the ON signal at the timing T1, the ON signal is inverted by the NOT circuit NT, so that the transistor QS enters the OFF state.

When the transistor QS is turned off, the voltages at the points B and C increase, and the DT voltage also increases, so that the duty ratio indicated by the output drive signal increases. Here, the voltage at the point C increases with the time constant of the resistance element R8 and the capacitor Cs, and the voltage at the point B also increases through the rectifier diode D1. As a result, the output power from the converter circuit 1 also increases.

On the other hand, as the voltages at the points B and C increase, the current (diode current) flowing through the light-emitting diode HD2 of the photocoupler PC2 conversely decreases. As a result, the output impedance on the secondary side of the photocoupler PC2 increases, the voltage at the point D increases due to the current flowing from the frequency control terminal (VCOin terminal) of the drive control circuit 50, and the VCO voltage also increases. As a result, the switching frequency indicated by the output drive signal is controlled in a direction of decreasing from the upper limit frequency.

As described above, in the present embodiment, in response to the input of the OFF signal (corresponding to the first instruction signal), the adjustment circuit 70 sets the DT voltage to a voltage level corresponding to the lower limit value of duty ratio (in the present embodiment, the duty ratio is 0) and sets the VCO voltage to a voltage level corresponding to a predetermined high frequency (upper limit frequency) higher than the resonant frequency of the series resonant circuit 11, and in response to switching from the input of the OFF signal to the input of the ON signal (corresponding to the second instruction signal), the adjustment circuit varies the DT voltage so that the duty ratio indicated by the drive signal increases and varies the VCO voltage so that the switching frequency indicated by the drive signal decreases.

Therefore, according to the present embodiment, by setting the duty ratio to the lower limit value (the duty ratio of zero in the present embodiment) while setting the operating frequency in the frequency range higher than the resonant frequency, the output voltage from the converter circuit 1 can be set to the predetermined lower limit voltage level (zero in the present embodiment) that is difficult to realize only by the frequency control in the LLC resonant converter circuit. Furthermore, by gradually increasing the duty ratio from the lower limit value, the output voltage from the converter circuit 1 can be gradually increased from the predetermined lower limit voltage level, and furthermore, the output voltage can be adjusted from the predetermined lower limit voltage level in the low voltage region including zero and stabilized at the set voltage level.

The voltage at the point C and the DT voltage gradually increase from the timing T1, and reach the upper limit level at the timing T2. As a result, after the timing T2, the duty ratio indicated by the drive signal also becomes the upper limit value (maximum duty ratio). As described above, the upper limit levels of the voltage at the point C and the DT voltage are determined by the resistance values of the resistance elements R8 and R9 and the variable resistor VR2. As described above, the rise time of the voltage at the point C and the DT voltage (the time from the timing T1 to the timing T2) is determined in response to the time constants of the resistance element R8 and the capacitor Cs, and the time is a period during which the PWM control (duty ratio control) is executed.

On the other hand, the voltage at the point B still increases even when the voltage at the point C and the DT voltage reach the upper limit.

At this time, a voltage at the point D and the VCO voltage further increase, and as a result, a switching frequency indicated by an output drive signal is also controlled in a direction to decrease from an upper limit frequency. At this time, the duty ratio indicated by the drive signal is the upper limit value, and the output voltage from the converter circuit 1 increases.

As a result, when the output voltage detected by the detection circuit 40 increases and the voltage of the slider of the variable resistor VR1 is about to become higher than the reference voltage, the diode current of the photocoupler PC1 increases, so that the output impedance on the secondary side turns to decrease, and the increase in the voltage at the point B is limited. Accordingly, the increase in the voltage at the point D and the VCO voltage is also limited by the action of the photocoupler PC2, and as a result, the decrease in the switching frequency indicated by the output drive signal is also limited.

This timing is indicated by the timing T3 in the graph of FIG. 2, and thereafter, the variation of the switching frequency is stabilized, and the output voltage from the converter circuit 1 is stabilized at a predetermined set voltage level. That is, the time from the timing T1 to the timing T3 is a period during which the PFM control is executed.

As described above, in the present embodiment, the adjustment circuit 70 suppresses variation of the frequency control voltage (VCO voltage) in a case where the divided voltage (voltage of the slider of the variable resistor VR1) is about to become higher than the reference voltage in a state where the second instruction signal (ON signal) is input. That is, in the present embodiment, the output is controlled so as to have a constant set voltage by the PFM control in an output region having a certain height.

Therefore, according to the present embodiment, the output voltage from the converter circuit 1 is adjusted from the predetermined lower limit voltage level in the low-voltage region including zero, and can be stabilized at the set voltage level higher than the low voltage region.

Furthermore, as described above, the voltage at the point C and the DT voltage gradually increase from the timing T1, and are limited at the upper limit level after the timing T2, and the voltage at the point D and the VCO voltage gradually increase from the timing T1, continue to increase after the timing T2, and are limited at the timing T3. As a result, after the instruction signal is switched from the OFF signal to the ON signal at the timing T1, the duty ratio indicated by the drive signal becomes the upper limit value (maximum duty ratio) after the timing T2, and the switching frequency indicated by the drive signal becomes the lower limit value (frequency higher than the resonant frequency) after the timing T3.

That is, in the present embodiment, the adjustment circuit 70 is configured such that a first variation time of the duty control voltage (DT voltage), which occurs with a switch from the input of the first instruction signal (OFF signal) to the input of the second instruction signal (ON signal), is shorter than the second variation time of the frequency control voltage (VCO voltage) that occurs with the switching. The first variation time is a time required to vary the duty control voltage (DT voltage) from a voltage level corresponding to the lower limit value of the duty ratio (which is a duty ratio of zero in the present embodiment) to a voltage level corresponding to the upper limit value of the duty ratio. The second variation time is a time period from when the frequency control voltage (VCO voltage) varies from a voltage level corresponding to a predetermined high frequency (upper limit frequency) until the variation is suppressed.

The timing at which the frequency control voltage (VCO voltage) is suppressed is approximate to the timing at which the output voltage reaches a predetermined set voltage level.

By making the first variation time of the DT voltage shorter than the second variation time of the VCO voltage in this manner, it is possible to control the output such that the PWM control (duty ratio control) is stopped in an output region of a certain height and the voltage becomes a constant set voltage by the PFM control while realizing a low output region by the PWM control. In the PWM control, hard switching is performed, but the PWM control is limited to the low output range, so that no particular problem occurs in the circuit.

### Modification Example

The contents of the above-described embodiments can be modified as appropriate. That is, the present embodiment is not limited to the circuit configuration illustrated in FIG. 1.

In FIG. 1, a configuration in which the switching elements Q11 and Q12 are connected in a half-bridge manner is illustrated as an example; however the configuration may also be modified to a configuration in which four switching elements are connected in a full-bridge manner. In this modification example, the drive control circuit 50 may include output terminals for drive signals for four channels, or may include output terminals for drive signals for two channels. In the former case, the drive circuit 13 may respectively control the operation of the switching element corresponding to each channel in response to the drive signal of each channel. In the latter case, in response to the drive signal of one channel, the drive circuit 13 may control the operation of the pair of switching elements corresponding to the one channel.

In addition, the above-described embodiment may be modified such that the switching element QS enters the ON state by the input of the ON signal, and the switching element QS enters the OFF state by the input of the OFF signal. In this case, the NOT circuit NT is unnecessary.

Furthermore, by modifying the above-described embodiment, the drive control circuit 50 may be configured to output a drive signal indicating a lower duty ratio as the DT voltage is higher within a predetermined range, and output a drive signal indicating a higher duty ratio as the DT voltage is lower within the predetermined range. In addition, the drive control circuit 50 may be configured to output a drive signal indicating a higher switching frequency as the VCO voltage is higher within a predetermined range, and output a drive signal indicating a lower switching frequency as the VCO voltage is lower within the predetermined range. In this case, the adjustment circuit 70 may be configured to lower the DT voltage so that the duty ratio indicated by the drive signal increases and lower the VCO voltage so that the switching frequency indicated by the drive signal decreases in response to switching from the input of the first instruction signal (OFF signal) to the input of the second instruction signal (ON signal).

Some or all of the above-described embodiments and modification examples can also be specified as follows. However, the above-described embodiments and modification examples are not limited to the following description.
<1>

A control circuit for an LLC resonant converter circuit, the control circuit controlling a switching frequency to be a frequency equal to or higher than a resonant frequency of a series resonant circuit, the LLC resonant converter circuit including the series resonant circuit, a drive circuit that is connected to the series resonant circuit and causes each of a plurality of switching elements to perform a switching operation based on a drive signal, a transformer that uses a resonant coil constituting the series resonant circuit as a primary winding, and a rectifier circuit that rectifies and smooths AC power generated in a secondary winding of the transformer, the control circuit including
a drive control circuit that includes a frequency control terminal and a duty control terminal and outputs drive signals indicating a switching frequency corresponding to a voltage level of the frequency control terminal and a duty ratio corresponding to a voltage level of the duty control terminal to the drive circuit,
a detection circuit that detects an output voltage from the LLC resonant converter circuit and stabilizes the output voltage to become a set voltage level,
a voltage dividing circuit that divides an input voltage from a control power supply terminal and applies the divided voltage as a duty control voltage to the duty control terminal, and
an adjustment circuit that is connected to the voltage dividing circuit and the detection circuit, is capable of adjusting the duty control voltage, and is capable of adjusting a frequency control voltage applied to the frequency control terminal based on the input voltage and the output voltage detected by the detection circuit, in which
in response to switching from an input of a first instruction signal to an input of a second instruction signal, the adjustment circuit varies the duty control voltage such that a duty ratio indicated by the drive signal increases, and varies the frequency control voltage such that a switching frequency indicated by the drive signal decreases.
<2>

The control circuit for the LLC resonant converter circuit according to <1>, in which
the adjustment circuit sets the duty control voltage to a voltage level corresponding to a lower limit value of duty ratio and sets the frequency control voltage to a voltage level corresponding to a predetermined high frequency higher than the resonant frequency in response to an input of the first instruction signal.
<3>

The control circuit for the LLC resonant converter circuit according to <2>, in which
the detection circuit includes
an output variable circuit capable of variably setting a voltage level of the output voltage from the LLC resonant converter circuit, and
a stabilization circuit that stabilizes the output voltage from the LLC resonant converter circuit to be at the set voltage level set by the output variable circuit by comparing a divided voltage of the detected output voltage with a reference voltage, and
the adjustment circuit suppresses variation of the frequency control voltage in a case where the divided voltage is about to become higher than the reference voltage in a state where the second instruction signal is input.
<4>

The control circuit for the LLC resonant converter circuit according to <3>, in which
the adjustment circuit is configured such that a first variation time of the duty control voltage associated with switching from the input of the first instruction signal to the input of the second instruction signal is shorter than a second variation time of the frequency control voltage associated with the switching,
the first variation time is a time required to vary the duty control voltage from a voltage level corresponding to the lower limit value of duty ratio to a voltage level corresponding to the upper limit value of duty ratio, and
the second variation time is a time period from when the frequency control voltage varies from the voltage level corresponding to the predetermined high frequency until the variation is suppressed.
<5>

The control circuit for the adjustment circuit according to <3>or <4>, in which
the adjustment circuit includes
a first light-emitting diode in which a current flowing therethrough increases in a case where the divided voltage is about to become higher than the reference voltage,
a first phototransistor that constitutes a first photocoupler together with the first light-emitting diode,
a rectifier diode and a first resistance element that are provided in series with a branch line that branches from an output line of the duty control voltage from the voltage dividing circuit to the duty control terminal and connects to a ground line,
a second resistance element and a second light-emitting diode that are connected in parallel with the voltage dividing circuit to a line that extends from the control power supply terminal and connects to the ground line, and
a second phototransistor that constitutes a second photocoupler together with the second light-emitting diode,
a line in which the second light-emitting diode and the second resistance element are provided in series is connected to the branch line on a cathode side of the second light-emitting diode,
the second phototransistor is provided in a line extending from the frequency control terminal and leading to the ground line,
an emitter terminal of the first phototransistor is connected to the ground line, and
a photocoupler output line extending from a collector terminal of the first phototransistor is connected between a cathode of the rectifier diode and the first resistance element in the branch line.
<6>

The control circuit for the LLC resonant converter circuit according to <5>, in which
the adjustment circuit further includes a switching element in which an emitter terminal is connected to a ground line, a collector terminal is connected to the photocoupler output line, and the switching element enters an ON state in response to an input of the first instruction signal and enters an OFF state in response to an input of the second instruction signal,
when the switching element is in the ON state, the photocoupler output line and a cathode side of the rectifier diode drop to a ground level, so that the duty control voltage applied to the duty control terminal becomes to a voltage level corresponding to the lower limit value of duty ratio.
<7>

An LLC resonant converter circuit including
the control circuit according to any one of <1>to <6>,
the series resonant circuit,
the drive circuit,
the transformer, and
the rectifier circuit.
<8>

A control method for an LLC resonant converter circuit, the LLC resonant converter circuit including
a series resonant circuit,
a drive circuit that is connected to the series resonant circuit and causes each of a plurality of switching elements to perform a switching operation based on a drive signal,
a transformer that uses a resonant coil constituting the series resonant circuit as a primary winding,
a rectifier circuit that rectifies and smooths AC power generated in a secondary winding of the transformer,
a drive control circuit that includes a frequency control terminal and a duty control terminal and outputs drive signals indicating a switching frequency corresponding to a voltage level of the frequency control terminal and a duty ratio corresponding to a voltage level of the duty control terminal to the drive circuit,
a detection circuit that detects an output voltage from the rectifier circuit and stabilizes the output voltage to become a set voltage level,
a voltage dividing circuit that divides a voltage of input power from a control power supply terminal and applies the divided voltage as a duty control voltage to the duty control terminal, and
an adjustment circuit that is connected to the voltage dividing circuit and the detection circuit, is capable of adjusting the duty control voltage, and is capable of adjusting a frequency control voltage applied to the frequency control terminal based on the input power and the output voltage detected by the detection circuit, the method including
in response to switching from an input of a first instruction signal to an input of a second instruction signal, varying the duty control voltage such that the duty ratio of the drive signal increases and varying the frequency control voltage such that the switching frequency of the drive signal decreases.
<9>

The control method for the LLC resonant converter circuit according to <8>, further including
setting the duty control voltage to a voltage level corresponding to a lower limit value of duty ratio, and setting the frequency control voltage to a voltage level corresponding to a predetermined high frequency that is higher than a resonant frequency of the series resonant circuit, in response to an input of the first instruction signal.
<10>

The control method for an LLC resonant converter circuit according to <9>, in which
the detection circuit includes an output variable circuit that is capable of variably setting a voltage level of an output voltage from the LLC resonant converter circuit, and a stabilization circuit that stabilizes the output voltage from the LLC resonant converter circuit to become the set voltage level set by the output variable circuit, based on a comparison between a divided voltage of the detected output voltage and a reference voltage, the method further including
in a state where the second instruction signal is input, in a case where the divided voltage is about to become higher than the reference voltage, suppressing variation of the frequency control voltage.
<11>

The control method for an LLC resonant converter circuit according to <10>, in which
a first variation time of the duty control voltage associated with switching from the input of the first instruction signal to the input of the second instruction signal is shorter than a second variation time of the frequency control voltage associated with the switching,
the first variation time is a time required to vary the duty control voltage from a voltage level corresponding to the lower limit value of duty ratio to a voltage level corresponding to the upper limit value of duty ratio, and
the second variation time is a time period from when the frequency control voltage varies from the voltage level corresponding to the predetermined high frequency until the variation is suppressed.

### REFERENCE SIGNS LIST

1 LLC resonant converter circuit (converter circuit)
3 Transformer
10 Primary-side circuit
11 Series resonant circuit
13 Drive circuit
20 Secondary-side circuit
21 Rectifier circuit
30 Control circuit
40 Detection circuit
50 Drive control circuit
60 Voltage dividing circuit
70 Adjustment circuit
VR1, VR2 Variable resistors
IC Shunt regulator
PC1, PC2 Photocoupler
QS, Q11, Q12 Switching element (transistor)
NT NOT circuit
HD1, HD2 Light-emitting diode
PQ1, PQ2 Phototransistor

1. A control circuit for an LLC resonant converter circuit, the control circuit controlling a switching frequency to be a frequency equal to or higher than a resonant frequency of a series resonant circuit, the LLC resonant converter circuit including the series resonant circuit, a drive circuit that is connected to the series resonant circuit and causes each of a plurality of switching elements to perform a switching operation based on a drive signal, a transformer that uses a resonant coil constituting the series resonant circuit as a primary winding, and a rectifier circuit that rectifies and smooths alternating current (AC) power generated in a secondary winding of the transformer, the control circuit comprising:
a drive control circuit that includes a frequency control terminal and a duty control terminal and outputs drive signals indicating a switching frequency corresponding to a voltage level of the frequency control terminal and a duty ratio corresponding to a voltage level of the duty control terminal to the drive circuit;
a detection circuit that detects an output voltage from the LLC resonant converter circuit and stabilizes the output voltage to become a set voltage level;
a voltage dividing circuit that divides an input voltage from a control power supply terminal and applies the divided voltage as a duty control voltage to the duty control terminal; and
an adjustment circuit that is connected to the voltage dividing circuit and the detection circuit, is capable of adjusting the duty control voltage, and is capable of adjusting a frequency control voltage applied to the frequency control terminal based on the input voltage and the output voltage detected by the detection circuit, wherein
in response to switching from an input of a first instruction signal to an input of a second instruction signal, the adjustment circuit varies the duty control voltage such that a duty ratio indicated by the drive signal increases, and varies the frequency control voltage such that a switching frequency indicated by the drive signal decreases.

2. The control circuit for the LLC resonant converter circuit according to claim 1, wherein
the adjustment circuit sets the duty control voltage to a voltage level corresponding to a lower limit value of duty ratio and sets the frequency control voltage to a voltage level corresponding to a predetermined high frequency higher than the resonant frequency in response to an input of the first instruction signal.

3. The control circuit for the LLC resonant converter circuit according to claim 2, wherein
the detection circuit includes
an output variable circuit capable of variably setting a voltage level of the output voltage from the LLC resonant converter circuit, and
a stabilization circuit that stabilizes the output voltage from the LLC resonant converter circuit to be at the set voltage level set by the output variable circuit by comparing a divided voltage of the detected output voltage with a reference voltage, and
the adjustment circuit suppresses variation of the frequency control voltage in a case where the divided voltage is about to be higher than the reference voltage in a state where the second instruction signal is input.

4. The control circuit for the LLC resonant converter circuit according to claim 3, wherein
the adjustment circuit is configured such that a first variation time of the duty control voltage associated with switching from the input of the first instruction signal to the input of the second instruction signal is shorter than a second variation time of the frequency control voltage associated with the switching,
the first variation time is a time required to vary the duty control voltage from a voltage level corresponding to the lower limit value of duty ratio to a voltage level corresponding to the upper limit value of duty ratio, and
the second variation time is a time period from when the frequency control voltage varies from the voltage level corresponding to the predetermined high frequency until the variation is suppressed.

5. The control circuit for the LLC resonant converter circuit according to claim 3 or 4 claim 3, wherein
the adjustment circuit includes
a first light-emitting diode in which a current flowing therethrough increases in a case where the divided voltage is about to become higher than the reference voltage,
a first phototransistor that constitutes a first photocoupler together with the first light-emitting diode,
a rectifier diode and a first resistance element that are provided in series with a branch line that branches from an output line of the duty control voltage from the voltage dividing circuit to the duty control terminal and connects to a ground line,
a second resistance element and a second light-emitting diode that are connected in parallel with the voltage dividing circuit to a line that extends from the control power supply terminal and connects to the ground line, and
a second phototransistor that constitutes a second photocoupler together with the second light-emitting diode,
a line in which the second light-emitting diode and the second resistance element are provided in series is connected to the branch line on a cathode side of the second light-emitting diode,
the second phototransistor is provided in a line extending from the frequency control terminal and leading to the ground line,
an emitter terminal of the first phototransistor is connected to the ground line, and
a photocoupler output line extending from a collector terminal of the first phototransistor is connected between a cathode of the rectifier diode and the first resistance element in the branch line.

6. The control circuit for the LLC resonant converter circuit according to claim 5, wherein
the adjustment circuit further includes a switching element in which an emitter terminal is connected to a ground line, a collector terminal is connected to the photocoupler output line, and the switching element enters an ON state in response to an input of the first instruction signal and enters an OFF state in response to an input of the second instruction signal, and
when the switching element is in the ON state, the photocoupler output line and a cathode side of the rectifier diode drop to a ground level, so that the duty control voltage applied to the duty control terminal becomes to a voltage level corresponding to the lower limit value of duty ratio.

7. An LLC resonant converter circuit comprising:
the control circuit according to claim 1;
the series resonant circuit;
the drive circuit;
the transformer; and
the rectifier circuit.

8. A control method for an LLC resonant converter circuit, the LLC resonant converter circuit including
a series resonant circuit,
a drive circuit that is connected to the series resonant circuit and causes each of a plurality of switching elements to perform a switching operation based on a drive signal,
a transformer that uses a resonant coil constituting the series resonant circuit as a primary winding,
a rectifier circuit that rectifies and smooths AC power generated in a secondary winding of the transformer,
a drive control circuit that includes a frequency control terminal and a duty control terminal and outputs drive signals indicating a switching frequency corresponding to a voltage level of the frequency control terminal and a duty ratio corresponding to a voltage level of the duty control terminal to the drive circuit,
a detection circuit that detects an output voltage from the rectifier circuit and stabilizes the output voltage to become a set voltage level,
a voltage dividing circuit that divides a voltage of input power from a control power supply terminal and applies the divided voltage as a duty control voltage to the duty control terminal, and
an adjustment circuit that is connected to the voltage dividing circuit and the detection circuit, is capable of adjusting the duty control voltage, and is capable of adjusting a frequency control voltage applied to the frequency control terminal based on the input power and the output voltage detected by the detection circuit, the method comprising:
in response to switching from an input of a first instruction signal to an input of a second instruction signal, varying the duty control voltage such that the duty ratio of the drive signal increases and varying the frequency control voltage such that the switching frequency of the drive signal decreases.

9. The control method for the LLC resonant converter circuit according to claim 8, further comprising:
setting the duty control voltage to a voltage level corresponding to a lower limit value of duty ratio, and setting the frequency control voltage to a voltage level corresponding to a predetermined high frequency that is higher than a resonant frequency of the series resonant circuit, in response to an input of the first instruction signal.

10. The control method for an LLC resonant converter circuit according to claim 9, wherein
the detection circuit includes an output variable circuit that is capable of variably setting a voltage level of an output voltage from the LLC resonant converter circuit, and a stabilization circuit that stabilizes the output voltage from the LLC resonant converter circuit to become the set voltage level set by the output variable circuit, based on a comparison between a divided voltage of the detected output voltage and a reference voltage, the method further comprising:
in a state where the second instruction signal is input, in a case where the divided voltage is about to become higher than the reference voltage, suppressing variation of the frequency control voltage.

11. The control method for an LLC resonant converter circuit according to claim 10, wherein
a first variation time of the duty control voltage associated with switching from the input of the first instruction signal to the input of the second instruction signal is shorter than a second variation time of the frequency control voltage associated with the switching,
the first variation time is a time required to vary the duty control voltage from a voltage level corresponding to the lower limit value of duty ratio to a voltage level corresponding to the upper limit value of duty ratio, and
the second variation time is a time period from when the frequency control voltage varies from the voltage level corresponding to the predetermined high frequency until the variation is suppressed.
